(19) United States
(12) Patent Application Publication
(10) Pub. No.: US 2020/0249332 A1
(43) Pub. Date: Aug. 6, 2020

(54) Online Extrinsic Miscalibration Detection Between Sensors

(71) Applicant: Ford Global Technologies, LLC, Dearborn, MI (US)

(72) Inventors: Gaurav Pandey, Foster City, CA (US); James Howarth, San Jose, CA (US); Siddharth Tanwar, Menlo Park, CA (US); Adolfo Apolloni, Forest Grove, OR (US)

(21) Appl. No.: 16/269,173

(22) Filed: Feb. 6, 2019

(51) Int. Cl. G01S 7/497; G01S 17/02; G01S 17/93; G01S 17/42

(52) U.S. Cl. CPC G01S 7/4972; G01S 17/42; G01S 17/936; G01S 17/023

(57) ABSTRACT

Various examples of online extrinsic miscalibration detection between sensors are described. A feature in a high-definition (HD) map of a region is detected with first sensor data from a first sensor of a vehicle and second sensor data from a second sensor of the vehicle as the vehicle traverses through the region. Miscalibration of one of the first sensor and the second sensor is estimated based on a result of the detecting.

### TECHNICAL FIELD

The present disclosure generally relates to sensor calibration and, more particularly, to online extrinsic miscalibration detection between sensors.

### BACKGROUND

Various automated applications rely on the use of multiple sensors such as Light Detection and Ranging (LiDAR) sensors, cameras, radars, and global navigation satellite system (GNSS)/inertial navigation system (INS). Among such applications, automated driving of autonomous vehicles (AVs) in particular tends to be heavily dependent on a suite of sensors functioning synergistically. For example, multiple sensors on an AV are important for robustly performing tasks such as localization, mapping and perception (e.g., detection and tracking of pedestrians/vehicles, detection of lane marking, and detection of traffic lights/signs).

Extrinsic calibration refers to the rigid transformation (also known as extrinsic parameters) between reference frames of the various sensors. Miscalibration of the extrinsic parameters can severely degrade the performance of the tasks of perception and localization, since such tasks typically rely on the assumption of accurate calibration of sensors. This means miscalibration could lead to critical system failures.

Miscalibration during vehicle operation usually result from physical perturbations to the position and/or orientation of the sensors on a vehicle. Perturbations can occur for a variety of reasons such as bad road conditions, wear and tear on sensor mounts and/or malicious manipulation of sensor hardware. Furthermore, perturbations and miscalibration can take place at any time during the operation of the vehicle.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a diagram of an example pipeline of miscalibration detection using a HD map in accordance with the present disclosure.

FIG. 2 is a diagram of an example scenario of feature detection in a camera frame in accordance with the present disclosure.

FIG. 3 is a diagram of an example scenario in accordance with the present disclosure.

FIG. 4 is a diagram of an example apparatus in accordance with an embodiment of the present disclosure.

FIG. 5 is a flowchart depicting an example process in accordance with an embodiment of the present disclosure.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

In view of the above, it is essential that there be a methodology that can detect inter-sensor miscalibration in an online fashion (e.g., during vehicle operation) and report a result of the detection (e.g., potential hazard due to miscalibration). Under a proposed scheme in accordance with the present disclosure, miscalibration of sensors may be checked and detected in-situ using objects that commonly appear in a road environment, without the need of placing special fiducial markers. In particular, under the proposed scheme, high-definition (HD) map data may be utilized to estimate the miscalibration rather than relying on sensor data alone. As AVs utilize HD map for navigation, HD map is essential for AV operations. Once an AV is localized in a HD map, exact locations of infrastructure objects, or features, on the HD map (e.g., traffic lights, traffic signs, lanes, light poles, fire hydrants and the like) as well as relative positions and orientations of such objects with respect to the AV can be known. Under the proposed scheme, infrastructure objects may be identified in the reference frame of various sensors on the AV and, thus, a miscalibration score may be computed by projecting the infrastructure objects from the reference frame of one sensor onto the reference frame of another sensor (e.g., based on current calibration parameters) to obtain a region of overlap between the projections. This is because, when calibration parameters of two sensors being compared are correct, an infrastructure object projected from a first reference frame would completely overlap the infrastructure object in a second reference frame. Moreover, since the locations of all the infrastructure objects of interests are known from the HD map, a miscalibration score may be computed when the AV is localized in a region of interest in the HD map (e.g., an area with a large number of objects and/or features).

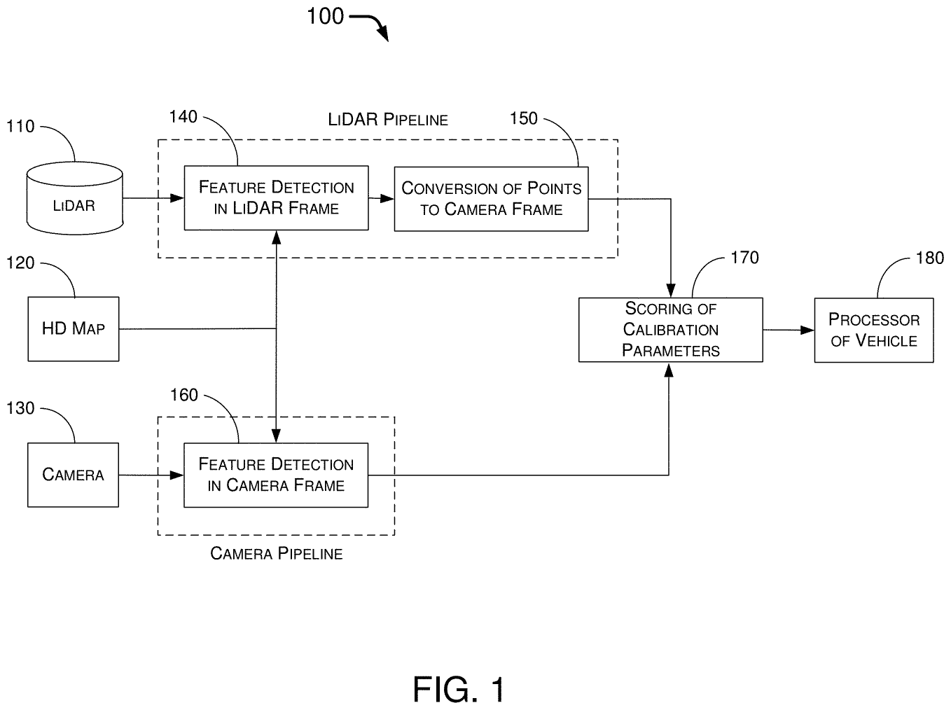

FIG. 1 illustrates an example pipeline 100 of miscalibration detection using a HD map in accordance with the present disclosure. Pipeline 100 may be utilized by an AV to detect miscalibrations in extrinsic parameters between perception sensors (e.g., a three-dimensional (3D) LiDAR sensor and a camera) in an online fashion using a HD map and to report severity of detected miscalibration to the AV.

Referring to FIG. 1, a HD map 120 may be utilized by an AV (e.g., processor 180 of the AV) to identify feature-rich regions in a current path of travel of the AV. For instance, from the aspect of a LiDAR sensor 110 on the AV, a function 140 of feature detection in LiDAR frame may be performed and the output of function 140 may be used by a function 150 of conversion of points to a camera frame. Similarly, from the aspect of a camera 130 on the AV, a function 160 of feature detection in the camera frame may be performed. Once the AV enters one of the feature-rich regions (e.g., having a relatively large number of traffic lights, traffic signs, lane markings, light poles and/or fire hydrants), miscalibration of LiDAR sensor 110 may be estimated or otherwise detected, and a miscalibration score may be computed for one or more current calibration parameters of LiDAR sensor 110.

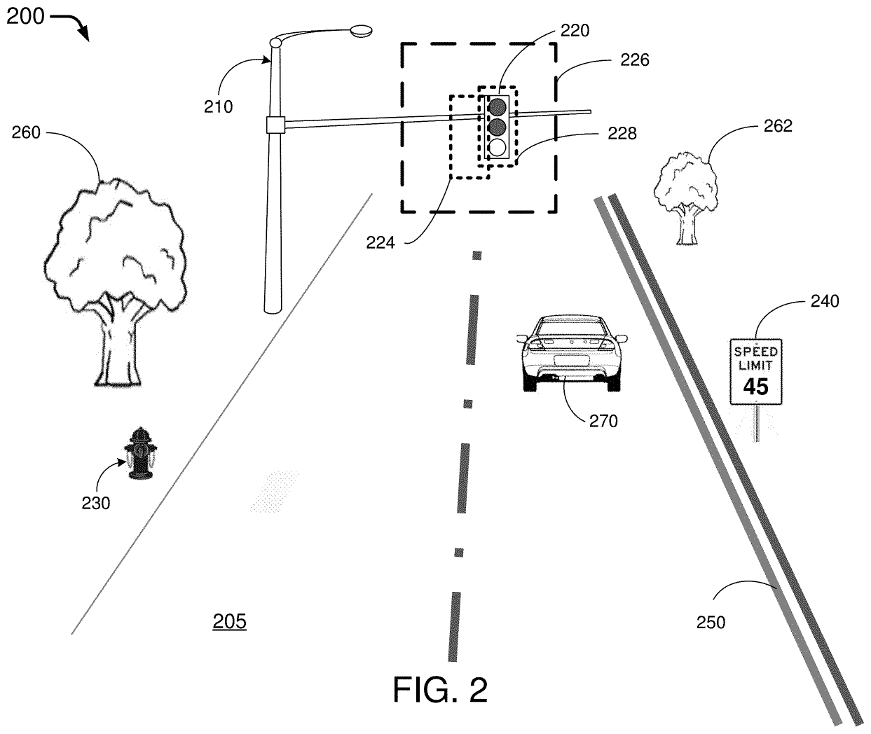

FIG. 2 illustrates an example scenario 200 of feature detection in a camera frame in accordance with the present disclosure. In scenario 200, a feature-rich region 205 may include a number of infrastructure objects as “features” in HD map 120 such as, for example, a light pole 210, a traffic light 220, a fire hydrant 230, a traffic sign 240 (e.g., speed limit sign), and lane markings 250. Location information (e.g., positioning coordinates), dimensions and other information of these infrastructure objects may be included in HD map 120. On the other hand, information of non-infrastructure objects (e.g., trees 260 and 262) and transient objects (e.g., vehicle 270) may not be included in HD map 120 since they are not utilized for miscalibration detection in accordance with the present disclosure.

Referring to both FIG. 1 and FIG. 2, once the AV enters feature-rich region 205, processor 180 may detect the feature-rich region 205 based on one or more camera images received from camera 130. Under the proposed scheme, a bounding box 224 around a given feature (e.g., traffic light 220) in a camera image may be detected with function 160 of feature detection in the camera frame, which is 2D. In particular, data from HD map 120 may be used to detect the presence of the feature (e.g., traffic light 220) in the field of view of camera 130. Moreover, bounding box 224, corresponding to the feature, may be identified around the feature in the camera frame to highlight the detection of the presence of the feature. Then, 3D points of the feature may be projected from HD map 120 onto the 2D camera frame corresponding to the camera image from camera 130. In an event that the AV is localized perfectly in HD map 120, the 3D points from HD map 120 would exactly align with the bounding box 224 around the feature in the camera image. However, due to errors in localization, there may be misalignment and, therefore, a search window 226 around the feature in the camera image may be identified. Search window 226 may be greater than bounding box 224 and may encompass bounding box 224 therein. For instance, the function 160 of feature detection in camera frame in the camera pipeline may be executed by processor 180 to perform object detection in the search window 226 to identify or otherwise detect a tight bounding box 228 around the feature, or traffic light 220 in this example. Tight bounding box 228 may be smaller than bounding box 224. Tight bounding box 228 may align with the feature better than bounding box 224, and tight box 228 may surround the feature more accurately and/or more snugly than bounding box 224. It is noteworthy that, although a traffic light is used in this example, a different infrastructure object or feature may be utilized.

Turning back to FIG. 1, the output of function 150 and the output of function 160 may be used by processor 180 to execute a function 170 of scoring of calibration parameters. That is, processor 180 can execute the function 170 of scoring of calibration parameters to compute and obtain a miscalibration score, based on an overlap between projected LiDAR sensor data corresponding to a detected feature and a bounding box surrounding/corresponding to the same feature computed directly from camera 130.

Function 140 of feature detection in LiDAR frame in the LiDAR pipeline may involve a number of operations. Firstly, a search space in a point cloud may be reduced by utilizing HD map 120. Since HD map 120 contains the location of various features, including the feature in concern (e.g., traffic light 220), the search space may be limited to be within a neighboring 3D space around the feature in concern. Next, a detection and target localization operation may be performed to identify points in the point cloud corresponding to the feature (e.g., traffic light 220). Then, any ambiguity may be resolved in a pruning operation.

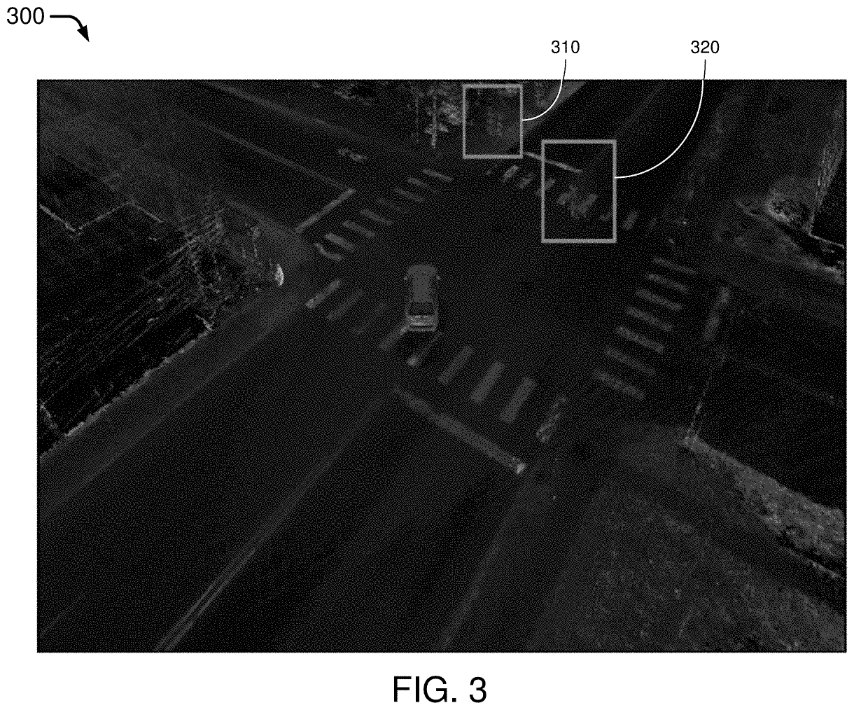

FIG. 3 illustrates an example scenario 300 in accordance with the present disclosure. In scenario 300, a LiDAR scan may be projected onto a 3D city map at an intersection. Each of boxes 310 and 320 shows respective LiDAR points in a respective point cloud corresponding to a respective one of two traffic lights at the intersection. These LiDAR points corresponding to the traffic lights may then be projected onto an image plane in the camera reference frame using current camera-LiDAR calibration parameters that are being tested and verified.

With the LiDAR points projected onto the camera frame, a score may be computed for the calibration parameters, for example, by using a statistical measure which incorporates the intersection over union (IoU) of a bounding box (e.g., one similar to bounding box 224 in FIG. 2) obtained from the camera image and the point projections onto the camera image from LiDAR sensor 110. Then, computed scores from a series of different perspectives generated by LiDAR sensor 110 and camera 130 may be aggregated as the AV traverses through a given region. The aggregation of accumulated scores may facilitate outlier rejection and noise reduction in the scores. Based on the computed score(s), a measure of miscalibration (if any) may be reported to a user of the AV and/or a third party (e.g., vendor of AV and/or repair shop).

In summary, the present disclosure provides a methodology to detect miscalibration in extrinsic parameters between perception sensors of a vehicle (e.g., AV, unmanned aerial vehicle (UAV) or robot). The methodology may involve using HD maps for vehicle localization. This allows the vehicle to identify objects of interest (e.g., infrastructure objects) and their exact positions. The objects of interest may include, for example and without limitation, traffic lights, traffic signs, lane markings, poles, fire hydrants and the like. The objects of interest may be identified in a sensors reference frame of each sensor. Images of the objects of interest may be projected from one sensor's reference frame onto another sensor's reference frame. If the two frames completely overlap, then the sensors are calibrated. If not, the methodology may calculate or otherwise compute a miscalibration score. The localization and identification of features of interest may be performed in an area with a large number of features (e.g., infrastructure objects). The area may be identified along a current travel path of the vehicle using the HD map.

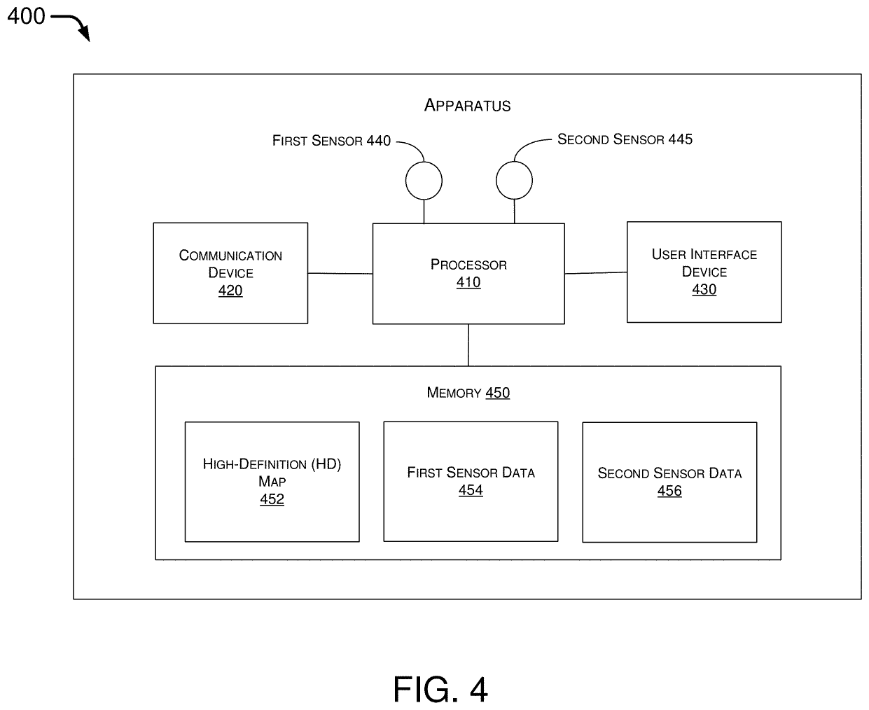

FIG. 4 illustrates an example apparatus 400 in accordance with an embodiment of the present disclosure. Apparatus 400 may include a number of components pertinent to the present disclosure as well as a number of components not directly pertinent to the present disclosure. Thus, in the interest of brevity and not obscuring illustration of pertinent components, FIG. 4 shows those components pertinent to various embodiments of the present disclosure without showing those components that are not directly pertinent to the present disclosure.

Referring to FIG. 4, apparatus 400 may include a processor 410, a communication device 420, a user interface device 430, a first sensor 440, a second sensor 445, and a memory 450. Apparatus 400 may be implemented in or as a part of an AV, UAV or robot as described herein.

Processor 410 may include one or more integrated-circuit (IC) chips. Communication device 420 may include a transceiver capable of wireless communications with one or more wireless networks and/or one or more other wireless communication devices. For instance, communication device 420 may wirelessly transmit a result of miscalibration estimation to a remote server (e.g., a vendor of apparatus 400 or the vehicle in which apparatus 400 is installed, a repair shop, or both). User interface device 430 may be capable of receiving user input from a user and providing visual and/or audible information to the user. For instance, user interface device 430 may include a touch-sensing panel, a display panel, a keypad, a speaker, a microphone, or any combination thereof. First sensor 440 may be a LiDAR sensor, and second sensor 445 may be an image sensor (e.g., an image sensor of a camera). Memory 450 may be accessible by processor 310 and capable of storing data (e.g., HD map 452, first sensor data 454 (e.g., LiDAR data) received from first sensor 440, and second sensor data 456 (e.g., image sensor data) received from second data 445). Memory 450 may include a type of random-access memory (RAM) such as dynamic RAM (DRAM), static RAM (SRAM), thyristor RAM (T-RAM) and/or zero-capacitor RAM (Z-RAM). Alternatively, or additionally, memory 450 may include a type of read-only memory (ROM) such as mask ROM, programmable ROM (PROM), erasable programmable ROM (EPROM) and/or electrically erasable programmable ROM (EEPROM). Alternatively, or additionally, memory 450 may include a type of non-volatile random-access memory (NVRAM) such as flash memory, solid-state memory, ferroelectric RAM (FeRAM), magnetoresistive RAM (MRAM) and/or phase-change memory.

Under a proposed scheme in accordance with the present disclosure, apparatus 400 may perform various operations to implement proposed schemes in accordance with the present disclosure. For instance, processor 410 may detect a feature in HD map 452 of a region with first sensor data 454 from first sensor 440 and second sensor data 456 from second sensor 445 as apparatus 400 (or a vehicle in/on which apparatus 400 is installed) traverses through the region. Moreover, processor 410 may estimate miscalibration of one of first sensor 440 and second sensor 450 based on a result of the detecting.

In some embodiments, in detecting the feature in the HD map, processor 410 may identify the feature in a first reference frame corresponding to first sensor 440. Additionally, processor 410 may identify the feature in a second reference frame corresponding to second sensor 445. In some embodiments, in estimating miscalibration of one of first sensor 440 and second sensor 450, processor 410 may project the feature from the first reference frame onto the second reference frame. Furthermore, processor 410 may compute a miscalibration score based on how much the feature projected from the first reference frame to the second reference frame overlaps the feature identified in the second reference frame.

In some embodiments, in detecting the feature in the HD map of the region with the first sensor data from first sensor 440 and the second sensor data from second sensor 445, process 500 may involve processor 410 detecting an infrastructure object in HD map 452 of the region with LiDAR data from first sensor 440 and an image captured by second sensor 445.

In some embodiments, the infrastructure object may include a traffic light, a traffic sign, a light pole, a lane marking, or a fire hydrant.

In some embodiments, in detecting the feature in the HD map of the region with the first sensor data from first sensor 440 and the second sensor data from second sensor 445, processor 410 may perform a number of operations. For instance, processor 410 may identify the region in HD map 452 having a plurality of infrastructure objects, including the infrastructure object, based on the image captured by second sensor 445. Additionally, processor 410 may detect presence of the infrastructure object in a field of view of second sensor 445 based on data from HD map 452. Moreover, processor 410 may identify a first bounding box around the infrastructure object based on the data from HD map 452 to highlight the detecting of the presence of the infrastructure object.

In some embodiments, in detecting the feature in the HD map of the region with the first sensor data from first sensor 440 and the second sensor data from second sensor 445, processor 410 may perform additional operations. For instance, processor 410 may project 3D points of the infrastructure object form HD map 452 onto a 2D image sensor frame corresponding to the image captured by second sensor 445. Moreover, in an event that the 3D points and the first bounding box are misaligned, processor 410 may identify a search window around the infrastructure object in the image, with the search window being greater than and encompassing the first bounding box. Furthermore, processor 410 may perform object detection in the search window to identify a second bounding box that surrounds and aligns with the infrastructure object better than the first bounding box.

In some embodiments, in detecting the feature in the HD map of the region with the first sensor data from first sensor 440 and the second sensor data from second sensor 445, processor 410 may perform other operations. For instance, processor 410 may conduct a search in a point cloud space in a 3D space represented by the LiDAR data in a LiDAR frame around a location of the infrastructure object according to HD map 452. Additionally, processor 410 may identify points in the point cloud that correspond to the infrastructure object. Moreover, processor 410 may project the identified points onto an image sensor frame corresponding to the image captured by second sensor 445.

In some embodiments, in estimating the miscalibration of one of first sensor 440 and second sensor 445 based on the result of the detecting, processor 410 may compute a miscalibration score based on how much the identified points projected onto the image sensor frame overlaps the feature identified in the image sensor frame by second sensor 445.

In some embodiments, processor 410 may perform additional operations. For instance, processor 410 may determine a level of severity of the miscalibration. Moreover, processor 410 may report a result of the determining. In some embodiments, in reporting, processor 410 may perform one of more of: (a) wirelessly transmitting, via communication device 420, the result of the determining to a remote server; (b) displaying, via user interface device 430, the result of the determining visually, audibly or both visually and audibly to a user of apparatus 400; and (c) recording, in memory 450, the result of the determining.

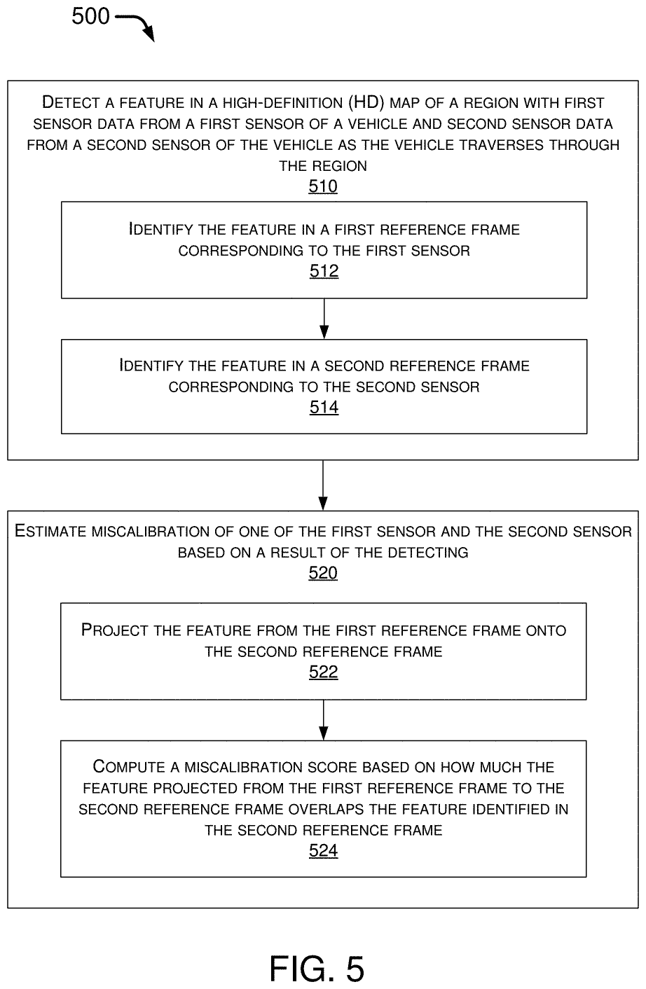

FIG. 5 illustrates a flowchart depicting an example process 500 in accordance with an embodiment of the present disclosure. Process 500 may include one or more operations, actions, or functions shown as blocks such as 510 and 520 as well as sub-blocks 512, 514, 522 and 524. Although illustrated as discrete blocks, various blocks/sub-blocks of process 500 may be divided into additional blocks, combined into fewer blocks, or eliminated, depending on the desired implementation. Moreover, some or all of the blocks/sub-blocks of FIG. 5 may be repeated. For illustrative purposes and without limitation, the following description of process 500 is provided with apparatus 400 implemented in or as a vehicle (e.g., an AV, UAV or robot). Process 500 may begin at block 510.

At 510, process 500 may involve processor 410 of apparatus 400 detecting a feature in a HD map (e.g., HD map 452) of a region with first sensor data from first sensor 440 and second sensor data from second sensor 445 as apparatus 400 (or a vehicle in/on which apparatus 400 is installed) traverses through the region. Process 500 may proceed from 510 to 520.

At 520, process 500 may involve processor 410 estimating miscalibration of one of first sensor 440 and second sensor 450 based on a result of the detecting.

In some embodiments, in detecting the feature in the HD map, process 500 may involve processor 410 performing a number of operations as represented by sub-blocks 512 and 514.

At 512, process 500 may involve processor 410 identifying the feature in a first reference frame corresponding to first sensor 440. Process 500 may proceed from 512 to 514.

At 514, process 500 may involve processor 410 identifying the feature in a second reference frame corresponding to second sensor 445.

In some embodiments, in estimating miscalibration of one of first sensor 440 and second sensor 450, process 500 may involve processor 410 performing a number of operations as represented by sub-blocks 522 and 524.

At 522, process 500 may involve processor 410 projecting the feature from the first reference frame onto the second reference frame. Process 500 may proceed from 522 to 524.

At 524, process 500 may involve processor 410 computing a miscalibration score based on how much the feature projected from the first reference frame to the second reference frame overlaps the feature identified in the second reference frame.

In some embodiments, in detecting the feature in the HD map of the region with the first sensor data from first sensor 440 and the second sensor data from second sensor 445, process 500 may involve processor 410 detecting an infrastructure object in HD map 452 of the region with Light Detection and Ranging (LiDAR) data from first sensor 440 as a LiDAR sensor and an image captured by second sensor 445 as an image sensor.

In some embodiments, the infrastructure object may include a traffic light, a traffic sign, a light pole, a lane marking, or a fire hydrant.

In some embodiments, in detecting the feature in the HD map of the region with the first sensor data from first sensor 440 and the second sensor data from second sensor 445, process 500 may involve processor 410 performing a number of operations. For instance, process 500 may involve processor 410 identifying the region in HD map 452 having a plurality of infrastructure objects, including the infrastructure object, based on the image captured by second sensor 445. Additionally, process 500 may involve processor 410 detecting presence of the infrastructure object in a field of view of second sensor 445 based on data from HD map 452. Moreover, process 500 may involve processor 410 identifying a first bounding box around the infrastructure object based on the data from HD map 452 to highlight the detecting of the presence of the infrastructure object.

In some embodiments, in detecting the feature in the HD map of the region with the first sensor data from first sensor 440 and the second sensor data from second sensor 445, process 500 may involve processor 410 performing additional operations. For instance, process 500 may involve processor 410 projecting 3D points of the infrastructure object form HD map 452 onto a 2D image sensor frame corresponding to the image captured by second sensor 445. Moreover, in an event that the 3D points and the first bounding box are misaligned, process 500 may involve processor 410 identifying a search window around the infrastructure object in the image, with the search window being greater than and encompassing the first bounding box. Furthermore, process 500 may involve processor 410 performing object detection in the search window to identify a second bounding box that surrounds and aligns with the infrastructure object better than the first bounding box.

In some embodiments, in detecting the feature in the HD map of the region with the first sensor data from first sensor 440 and the second sensor data from second sensor 445, process 500 may involve processor 410 performing other operations. For instance, process 500 may involve processor 410 conducting a search in a point cloud space in a 3D space represented by the LiDAR data in a LiDAR frame around a location of the infrastructure object according to HD map 452. Additionally, process 500 may involve processor 410 identifying points in the point cloud that correspond to the infrastructure object. Moreover, process 500 may involve processor 410 projecting the identified points onto an image sensor frame corresponding to the image captured by second sensor 445.

In some embodiments, in estimating the miscalibration of one of first sensor 440 and second sensor 445 based on the result of the detecting, process 500 may involve processor 410 computing a miscalibration score based on how much the identified points projected onto the image sensor frame overlaps the feature identified in the image sensor frame by second sensor 445.

In some embodiments, process 500 may involve processor 410 performing additional operations. For instance, process 500 may involve processor 410 determining a level of severity of the miscalibration. Moreover, process 500 may involve processor 410 reporting a result of the determining. In some embodiments, in reporting, process 500 may involve processor 410 performing one of more of: (a) wirelessly transmitting, via communication device 420, the result of the determining to a remote server; (b) displaying, via user interface device 430, the result of the determining visually, audibly or both visually and audibly to a user of apparatus 400; and (c) recording, in memory 450, the result of the determining.

In the above disclosure, reference has been made to the accompanying drawings, which form a part hereof, and in which is shown by way of illustration specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, apparatuses, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the present disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure.

What is claimed is:

1. A method, comprising:
detecting a feature in a high-definition (HD) map of a region with first sensor data from a first sensor of a vehicle and second sensor data from a second sensor of the vehicle as the vehicle traverses through the region; and
estimating miscalibration of one of the first sensor and the second sensor based on a result of the detecting.

2. The method of claim 1, wherein the detecting of the feature in the HD map of the region with the first sensor data from the first sensor of a vehicle and the second sensor data from the second sensor of the vehicle comprises:
identifying the feature in a first reference frame corresponding to the first sensor; and
identifying the feature in a second reference frame corresponding to the second sensor.

3. The method of claim 2, wherein the estimating of the miscalibration of one of the first sensor and the second sensor based on the result of the detecting comprises:
projecting the feature from the first reference frame onto the second reference frame; and
computing a miscalibration score based on how much the feature projected from the first reference frame to the second reference frame overlaps the feature identified in the second reference frame.

4. The method of claim 1, wherein the detecting of the feature in the HD map of the region with the first sensor data from the first sensor of a vehicle and the second sensor data from the second sensor of the vehicle comprises detecting an infrastructure object in the HD map of the region with Light Detection and Ranging (LiDAR) data from a LiDAR sensor of the vehicle and an image captured by an image sensor of the vehicle.

5. The method of claim 4, wherein the infrastructure object comprises a traffic light, a traffic sign, a light pole, a lane marking, or a fire hydrant.

6. The method of claim 4, wherein the detecting of the feature in the HD map of the region with the first sensor data from the first sensor of a vehicle and the second sensor data from the second sensor of the vehicle comprises:
identifying the region in the HD map having a plurality of infrastructure objects, including the infrastructure object, based on the image captured by the image sensor;
detecting presence of the infrastructure object in a field of view of the image sensor based on data from the HD map; and
identifying a first bounding box around the infrastructure object based on the data from the HD map to highlight the detecting of the presence of the infrastructure object.

7. The method of claim 6, wherein the detecting of the feature in the HD map of the region with the first sensor data from the first sensor of a vehicle and the second sensor data from the second sensor of the vehicle further comprises:
projecting three-dimensional (3D) points of the infrastructure object form the HD map onto a two-dimensional (2D) image sensor frame corresponding to the image captured by the image sensor;
in an event that the 3D points and the first bounding box are misaligned, identifying a search window around the infrastructure object in the image, the search window greater than and encompassing the first bounding box; and
performing object detection in the search window to identify a second bounding box that surrounds and aligns with the infrastructure object better than the first bounding box.

8. The method of claim 6, wherein the detecting of the feature in the HD map of the region with the first sensor data from the first sensor of a vehicle and the second sensor data from the second sensor of the vehicle further comprises:
conducting a search in a point cloud space in a three-dimensional (3D) space represented by the LiDAR data in a LiDAR frame around a location of the infrastructure object according to the HD map;
identifying points in the point cloud that correspond to the infrastructure object; and
projecting the identified points onto an image sensor frame corresponding to the image captured by the image sensor.

9. The method of claim 8, wherein the estimating of the miscalibration of one of the first sensor and the second sensor based on the result of the detecting comprises computing a miscalibration score based on how much the identified points projected onto the image sensor frame overlaps the feature identified in the image sensor frame by the image sensor.

10. The method of claim 1, further comprising:
determining a level of severity of the miscalibration; and
reporting a result of the determining.

11. The method of claim 10, wherein the reporting comprises one of more of:
wirelessly transmitting the result of the determining to a remote server;
displaying the result of the determining visually, audibly or both visually and audibly to a user of the vehicle; and
recording the result of the determining.

12. An apparatus implementable in a vehicle, comprising:
a memory storing a high-definition (HD) map of a region;
a first sensor capable of sensing the region as the vehicle traverses through the region and providing first sensor data as a result of the sensing;
a second sensor capable of sensing the region as the vehicle traverses through the region and providing second sensor data as a result of the sensing; and
a processor coupled to the memory, the first sensor and the second sensor, the processor capable of:
detecting a feature in the HD map of the region with the first sensor data and the second sensor data; and
estimating miscalibration of one of the first sensor and the second sensor based on a result of the detecting.

13. The apparatus of claim 12, wherein, in detecting the feature in the HD map of the region with the first sensor data and the second sensor data, the processor is capable of:
identifying the feature in a first reference frame corresponding to the first sensor; and
identifying the feature in a second reference frame corresponding to the second sensor.

14. The apparatus of claim 13, wherein, in estimating the miscalibration of one of the first sensor and the second sensor based on the result of the detecting, the processor is capable of:
projecting the feature from the first reference frame onto the second reference frame; and
computing a miscalibration score based on how much the feature projected from the first reference frame to the second reference frame overlaps the feature identified in the second reference frame.

15. The apparatus of claim 12, wherein the first sensor comprises a Light Detection and Ranging (LiDAR) sensor, wherein the second sensor comprises an image sensor, and wherein the feature comprises an infrastructure object.

16. The apparatus of claim 15, wherein, in detecting the feature in the HD map of the region with the first sensor data and the second sensor data, the processor is capable of:
identifying the region in the HD map having a plurality of infrastructure objects, including the infrastructure object, based on the image captured by the image sensor;
detecting presence of the infrastructure object in a field of view of the image sensor based on data from the HD map; and
identifying a first bounding box around the infrastructure object based on the data from the HD map to highlight the detecting of the presence of the infrastructure object.

17. The apparatus of claim 16, wherein, in detecting the feature in the HD map of the region with the first sensor data and the second sensor data, the processor is further capable of:
projecting three-dimensional (3D) points of the infrastructure object form the HD map onto a two-dimensional (2D) image sensor frame corresponding to the image captured by the image sensor;
in an event that the 3D points and the first bounding box are misaligned, identifying a search window around the infrastructure object in the image, the search window greater than and encompassing the first bounding box; and
performing object detection in the search window to identify a second bounding box that surrounds and aligns with the infrastructure object better than the first bounding box.

18. The apparatus of claim 16, wherein, in detecting the feature in the HD map of the region with the first sensor data and the second sensor data, the processor is further capable of:
conducting a search in a point cloud space in a three-dimensional (3D) space represented by the LiDAR data in a LiDAR frame around a location of the infrastructure object according to the HD map;
identifying points in the point cloud that correspond to the infrastructure object; and
projecting the identified points onto an image sensor frame corresponding to the image captured by the image sensor.

19. The apparatus of claim 18, wherein, in estimating the miscalibration of one of the first sensor and the second sensor based on the result of the detecting, the processor is capable of computing a miscalibration score based on how much the identified points projected onto the image sensor frame overlaps the feature identified in the image sensor frame by the image sensor.

20. The apparatus of claim 12, wherein the processor is further capable of:
determining a level of severity of the miscalibration; and
reporting a result of the determining by performing one or more of:
wirelessly transmitting the result of the determining to a remote server;
displaying the result of the determining visually, audibly or both visually and audibly to a user of the vehicle; and
recording the result of the determining.
